(19) United States
(12) Patent Application Publication
(10) Pub. No.: US 2024/0302160 A1
(43) Pub. Date: Sep. 12, 2024

(54) MEASURING APPARATUS AND METHOD FOR DETERMINATION OF A MEASUREMENT VALUE ON AN OBJECT

(71) Applicant: Carl Mahr Holding GmbH, Goettingen (DE)

(72) Inventor: Markus Adam ECKHARDT, Noerten-Hardenberg (DE)

(21) Appl. No.: 18/598,572

(22) Filed: Mar. 7, 2024

(30) Foreign Application Priority Data
Mar. 8, 2023 (DE) 10 2023 105 685.9

(51) Int. Cl. G01B 11/00; G01B 11/24

(52) U.S. Cl. CPC G01B 11/005; G01B 11/2408

(57) ABSTRACT

A measuring apparatus and a method for determination of a measurement value of an object are disclosed. A sensor unit, produces one sensor signal respectively in different measuring positions along a positioning direction for multiple measurement points on an object, wherein the sensor signal describes the position of the measurement point. A positioning device positions the sensor unit and the object in the different measuring positions relative to one another in a positioning direction. The positioning or relative movement in the positioning direction is influenced by a periodic position deviation of the positioning device, which influences the detected sensor signals of the measurement points. A positioning characteristic describing the wavelength and/or the period of the periodic position deviation is determined. By means of the positioning characteristic, the sensor signals obtained for multiple measurement points in different measuring positions can be corrected to obtain the measurement value for the respective measurement point therefrom.

### CROSS REFERENCE TO RELATED APPLICATION

This application claims the benefit of German Patent Application No. 10 2023 105 685.9, filed Mar. 8, 2023, which is incorporated herein by reference in its entirety.

### TECHNICAL FIELD

The invention refers to a measuring apparatus as well as a method for measurement of an object, for example for measurement of one or more measurement values on an object and/or for determination of a characteristic value determined therefrom, e.g. a position in a coordinate system of the measuring apparatus, a contour, a surface profile of the object characterized by a sequence of measurement values, a roughness, a roundness, etc.

### BACKGROUND

DE 10 2012 111 008 B4 describes an optical measurement method as well as a measurement device for detection of a surface topography. By means of the method, position errors of the drive axes of the measurement device shall be determined and the measurement values shall be corrected. For this purpose, a sensor unit is provided having multiple channels which measures concurrently at multiple sites of the object surface. In doing so, inclinations of the sensor unit relative to the object can be determined and subsequently used for correction during the measurement value detection.

DE 197 21 915 C1 describes a method for measurement of unevenness formed by ripples or long undulations, of a rail along which the sensor unit is moved. For this purpose, a light line is directed in extension direction of the rail on its surface and the reflection of light is detected. Unevenness by ripples or undulations can be determined in this manner and can be eliminated in order to guarantee the correct drive operation.

EP 3 240 994 B1 discloses a measuring apparatus having a slide that can be moved along a guide. Due to the thermal inertia, the temperature of the slide at the same position along the guide is different during movement in forward direction and backward direction. From measurement values for the geometric deviations of an object an average value is determined during movement of the slide in forward direction and backward direction.

DE 101 28 623 A1 describes a measuring apparatus and a method carried out therewith during which a bending deformation of a guide of a sensor unit, for example due to the own weight, is determined and subsequently used for measurement value correction.

A method for image processing based on independent noise conditions is described in DE 10 2005 045 179 A1. For this purpose, multiple images are combined for improving image quality.

It is known from DE 20 2020 003 043 U1 to improve the composition of images of an image detection device.

As additional prior art reference is made to DE 23 17 361 B, DE 33 24 840 A1, DE 34 40 102 A1, DE 36 07 633 C2, DE 36 07 634 A1 and DE 43 18 427 A1.

It is a known problem that in measuring apparatuses for determination of a measurement value on an object, deviations can occur due to a non-ideal positioning between sensor unit and the object. In the prior art different possibilities are described how this problem can be encountered in order to improve the accuracy of the determined measurement value.

### SUMMARY

It can be considered as one object of the present invention to provide a possibility to increase the accuracy of a determined measurement value with means being as simple as possible.

This object is solved by means of a measuring apparatus, a method, as well as a computer program product as disclosed herein.

The measuring apparatus according to the invention is configured to determine a measurement value on an object. It has a sensor unit, a positioning device as well as a control device.

The sensor unit is configured to measure multiple measurement points on the object arranged next to each other, at least in one spatial direction—which is here denoted as positioning direction—and to produce for each measurement point a separate sensor signal assigned to the respective measurement point.

In order to measure multiple measurement points and to create respective sensor signals, the sensor unit can comprise, for example, a sensor element which is configured as matrix sensor, for example a matrix camera. For example, an object contour can be measured based on a light-dark transition on a matrix sensor in a transition light method using a matrix camera, wherein a measurement point can be assigned to a pixel or sub-pixel using a sub-pixel rendering, due to the light-dark transition. In addition, a measurement point can also be defined by average determination of multiple pixel or sub-pixel.

The positioning device of the measuring apparatus comprises a slide. The slide is movably supported along a guide in positioning direction. The positioning device is configured to position the slide in multiple different measuring positions in positioning direction. For example, the slide can be continuously moved during a measurement in positioning direction, whereby a quick measurement can be achieved. Alternatively, it is also possible to move the slide intermittently with phases of standstill in positioning direction. The positioning device comprises a position sensor and a scale assigned to the position sensor or another suitable position detection unit for positioning of the slide in the measuring positions.

Preferably the slide is moved without switching movement direction between the different measuring positions during a measurement.

The term “measurement” here means a process, which comprises the sensoric detection of at least one sensor value on the object (for example provided as sensor signal) and the determination of a measurement value from the at least one sensor value. Optionally the process comprises a processing of one or more measurement values (for example forming an average value) and/or the determination of characteristic value of the object (for example a roundness) from at least one sensor value and/or measurement value (processed and/or non-processed measurement value).

The described movement of the slide can optionally not only be carried out in one single spatial direction, but in multiple spatial directions, either concurrently or subsequently. Also, multiple slides can be provided that are configured respectively for a movement of the sensor unit or the object in one spatial direction. Thus, not only one single, but for example also two or three different positioning directions can be defined.

In each measuring position the sensor unit can measure multiple measurement points. The measuring directions are selected, so that a measurement point can be measured in different measuring positions. Therefore, for one or more or all measurement points one sensor signal is present in different measuring positions of the slide respectively.

A sensor unit can detect the sensor signals for the measurement points with a system-dependent frequency, for example with a specific maximum number of images per second, if a matrix camera is used as a sensor. Depending on the possible detection range of the sensor unit (for example size of the field of view) and provided that one common measurement point shall be detected on the object in directly subsequent measuring positions, a maximum drive velocity of the slide in positioning direction results therefrom.

The control device is communicatively connected with the sensor unit. The control device is configured to receive the sensor signals of the sensor unit. From sensor signals assigned to the same measurement point that have been measured in different measuring positions, the measurement value for the respective measurement point is determined using a known positioning characteristic of the positioning device. The positioning characteristic describes a spatial periodic position deviation of the positioning device during its movement or positioning of the slide in positioning direction along the guide. The position deviation can occur in one, multiple or all spatial directions. Substantially in the present case, particularly the position deviation orthogonal to the positioning direction and to the workpiece surface is considered. Particularly, the measurement value for the respective measurement point can be determined by averaging adapted to the known period or wavelength of the periodical position deviation described by the positioning characteristic.

In order to be able to determine the position of the measurement point on the object in positioning direction below the maximum possible resolution of the position sensor of the positioning device, in addition at least one feature or measurement point can be used, which is detected on the object by means of the sensor unit.

In order to be able to more precisely identify a measurement site or measurement point on the object and in order to reduce or eliminate deviations in positioning direction, one or more reference features of the object can be detected by means of the sensor unit and can be identified in different measuring positions. For example, a reference feature can be an edge, a depression, a projection and/or another arbitrary geometry on the object, which can be detected by means of the sensor unit, which can be preferably identified in an image of a matrix camera in different measuring positions.

Such a reference feature can also be a significant progress (periodic or aperiodic progress) of an object surface. A reference feature can also be a previously known characteristic feature of the object, such as the surface condition. The surface condition can be known from the construction data of the object, for example, and can be provided to the control device.

If the surface of the object has an aperiodic progress, which can be detected by means of the sensor unit (particularly matrix camera), an expected variance in the sensor signal can be determined for each measurement point or measurement site on the object having a known longitudinal extension in positioning direction. The variance in the sensor signals is particularly dependent on a positioning fuzziness of the measurement point or measurement site in the camera images of the different measuring positions under consideration of the aperiodic progress, caused by positioning errors in positioning direction. The measuring positions and/or longitudinal extensions of a measurement site can be selected so that the expected variance in the sensor signals with regard to the expected position deviation in positioning direction is sufficiently small (negligible) compared to the position deviation that can be detected by means of the sensor unit and the error during the determination of a measurement value based thereon. For example, the ratio can be predefined, for example by means of an allowable range.

If the surface of the object comprises a periodic progress, which can be detected by means of the sensor unit (for example a twist structure on the object), an averaging of the surface can be carried out so that at least two measurement points in each measuring position (for example two measurement points per image in different measuring positions) can be detected, wherein the longitudinal extension of each measurement point in positioning direction corresponds at least to an entire spatial period or multiple integer complete periods of the significant periodic progress of the object surface. In doing so, it is possible to achieve a determination of the measurement value by means of averaging, independent from the periodically varying progress of the object surface.

Additionally or alternatively, it is also possible to estimate an error during moving into a measuring position caused by the positioning device in positioning direction (particularly inaccurate measurement by means of a position sensor of the positioning device) and to correct it using a correction method. The estimation of the error in positioning direction can be determined depending on the determined error in another spatial direction. For example, the pixel of an image (sensor unit comprises matrix camera) referring to one measurement point and a misplacement in adjacent images can be compensated by means of a correction method (tracking of the pixel in positioning direction).

The positioning device is configured to produce a relative movement between the object and the sensor unit in order to reach different measuring positions. Thereby, the object of a sensor unit can be moved by means of the slide. The measuring apparatus can also comprise multiple positioning devices in order to move the object as well as the sensor unit along the respective guide in the respective positioning direction.

The positioning characteristic describes at least one invariant spatial parameter of the periodic position deviation, preferably exclusively a spatial wavelength of the periodic position deviation. Temporal parameters of the periodic position deviation, such as a temporal period or frequency, depend on additional influencing parameters, particularly from the velocity with which the slide is moved in positioning direction.

The positioning characteristic can be one single parameter.

The periodic position deviation of the positioning device of the measuring apparatus can be caused by the type of support of the slide on the guide, for example. This periodic position deviation can vary spatially during operation of the measuring apparatus in relation to an immovable coordinate system of the guide, particularly with regard to the relative position (phase position) and/or the amplitude. However, the spatial wavelength of the periodic position deviation is thereby constant. For example, the positioning device can have a support comprising components that move relative to the slide as well as relative to the guide during movement of the slide along the guide, such as a ball chain or another rolling body arrangement. In such a configuration it is also possible to determine the periodic position deviation of the positioning device in relation to each spatial position of the guide in the context of a calibration movement and to correct the sensor signals for determination of the measurement value based thereon. This is because the periodic position deviation varies spatially in positioning direction in its phase position within the immovable coordinate system. For this reason it is provided, according to the present invention, to determine and preset the positioning characteristic. Therefrom advantages and possibilities result. For example, the obtained sensor signals can be processed based on the positioning characteristic, particularly averaged over one or more complete periods or wavelengths. Additionally or alternatively, an optimized measurement detection strategy for the measurement system can be determined based on the positioning characteristic and can be used, for example for increasing the measurement accuracy, because the position deviation can be determined and can be corrected respectively. Additionally or alternatively, the spatial distribution of sensor signals and/or measurement points (spatial measurement sites) can be determined and measuring positions that are suitable for this purpose can be determined. Subsequently, measurement values can be detected there. This happens particularly under consideration of the spatially detectable measurement range of the sensor unit on the object.

Thus, according to the invention, a simple possibility is provided by means of which the positioning characteristic considers the periodic position deviation on the measured measurement points on the object caused by the positioning device and to calculate therefrom a measurement value, the accuracy of which is remarkably higher than the accuracy of the sensor signals that characterize the respective measurement point in the different measuring positions. It is sufficient, if the period or wavelength of the periodic position deviation is known by means of the positioning characteristic. Knowledge of the amplitude, the zero crossings, the phase position or additional characteristics of the periodic position deviation is not necessary.

The sensor unit can operate in a contactless manner and/or in a tactile manner and is preferably realized by means of an optically probing sensor unit. In an embodiment the sensor unit operates based on the transmitted light principle.

The object can be a workpiece, a reference standard or also an additional slide of an additional positioning device. Multiple slides or multiple positioning devices can be arranged in a stacked manner in the type of a compound slide or in another manner. In doing so, also sensor or measurement data of an additional sensor attached to an additional slide can be corrected, for example.

As already explained, particularly a parameter is determined as positioning characteristic, which describes the spatial wavelength of the periodic position deviation and/or a parameter depending thereon, for example the period of the periodic position deviation. The periodic position deviation is the spatial difference between the real slide position and an ideal slide position. The periodic position deviation of the positioning device can be detected in different ways and can be preset or provided to the control device. For example, the periodic position deviation can be measured using a reference object as object. On the reference object a reference area is detected by the sensor. The reference area comprises no or negligible deviations compared to a desired shape of the reference area. This can be realized, for example, by using a reference standard, which does only have very small manufacturing deviations compared with a desired shape of the reference standard or else by averaging of multiple measurement points on a workpiece, which can be concurrently detected in one measuring position. Thus, the averaged measurement value has an increased independency from local shape deviations of the object compared to a measurement value of a single measurement point. However, this area in which the measurement points are located in this (first) measuring position has to be also detectable in another (second) measuring position.

Additionally or alternatively to the method above, the periodic position deviation and the positioning characteristic derived therefrom can also be determined based on at least one construction parameter of the positioning device. In the embodiment the construction parameter can characterize a bearing of the slide on the guide. For example, the construction parameter can be a construction parameter of a rolling body arrangement, such as a circumference of the rolling bodies and/or a parameter correlated therewith (e.g. radius or diameter of the rolling bodies). Particularly, the wavelength of the periodic position deviation corresponds to the diameter of the rolling bodies of the rolling body arrangement. The nominal diameter of the rolling bodies can be used as diameter of the rolling bodies.

The sensor unit can comprise a transmitted light illumination and a sensor element arranged with distance to the transmitted light illumination. In a light emission direction at least a section of the object to be measured is arranged between the transmitted light illumination and the sensor element, so that at least a portion of the light emitted by the transmitted light illumination strikes the sensor element. Preferably, the light emission direction is thereby orientated orthogonal or obliquely to the positioning direction. For example, the light emission direction is defined by the optical axis of the transmitted light illumination.

As already explained, the positioning device can comprise a rolling body arrangement on the guide for supporting the slide. The rolling body can comprise circulating rolling bodies that move arrangement relative to the slide as well as relative to the guide during movement of the slide in positioning direction. Particularly, the rolling bodies circulate in a rolling body track, which is continuous in a ring-shaped manner. At least a section of the rolling body track is arranged between the slide and the guide. For example, the rolling body arrangement can comprise balls as rolling bodies. The balls can form a ball chain. In this embodiment the positioning characteristic can be defined by a construction parameter of the rolling body arrangement, such as the circumference of a rolling body (e.g. ball circumference). A periodic position deviation can be created by the circulating rolling bodies.

In the method according to the invention a measurement value or a characteristic parameter determined from multiple measurement values can be determined, wherein the method can be carried out using one or more embodiments of the measuring apparatus according to the invention.

First, the slide is moved in multiple different measuring positions in positioning direction by means of the positioning device. In each measuring position the sensor unit produces multiple sensor signals, wherein each sensor signal is associated with one measurement point (measurement site) on the object inside the detection range of the sensor unit and wherein the measurement points (measurement sites) are arranged adjacent to one another in positioning direction. The measuring positions, in which the sensor signals of the sensor unit are produced, are selected so that the detection ranges of the sensor unit on the object overlap in two directly adjacent measuring positions in measuring direction. Thereby, for multiple or all measurement points on the object, multiple sensor values exist respectively, wherein the sensor signals have been measured in different measuring positions by means of the sensor unit. The sensor signals of the same measurement point (measurement site) on the object that have been detected in at least two different measuring positions are used to determine a measurement value therefrom using the predefined positioning characteristic.

On a computer program product, according to the invention, commands can be stored, the execution of which causes the method according to the invention to be carried out. The computer program product can be a storage medium, which can be part of the measuring apparatus or can alternatively can be communicatively connected with the control device of the measuring apparatus, so that a processor of the control device is able to execute the stored commands in order to cause the measuring apparatus to carry out the method according to the invention.

### BRIEF DESCRIPTION OF THE DRAWINGS

Advantageous embodiments of the invention are derived from the dependent claims, the description and the drawings. In the following, preferred embodiments of the invention are explained in detail based on the attached drawings. The drawings show:

FIG. 1 a perspective illustration of an exemplary embodiment of a measuring apparatus,

FIG. 2 a schematic block-diagram-like illustration of a bearing of a slide of the measuring apparatus from FIG. 1 on a guide rail,

FIG. 3 a schematic principle illustration of a rolling body arrangement for support of the slide on the guide,

FIG. 4 a block diagram of the measuring apparatus from FIG. 1,

FIG. 5 an exemplary principle illustration of a periodic positioning characteristic of a positioning device of the measuring apparatus according to FIGS. 1 and 4,

FIG. 6 a principle illustration of the detection of a measurement point in different measuring positions,

FIG. 7 a block diagram of a modified embodiment of the measuring apparatus according to the invention having multiple positioning devices,

FIG. 8 an exemplary progress of a measurement value (here: distance value to a reference axis of the measuring apparatus) of multiple measurement points depending on the positioning direction,

FIG. 9 the contour progress of FIG. 8 formed from measurement values that have been determined under consideration of the periodic position deviation and

FIG. 10 a schematic illustration of the number of sensor signals per measurement point that have been used for determination of the periodic positioning characteristic during the determination of the measurement progress in FIG. 9.

### DETAILED DESCRIPTION

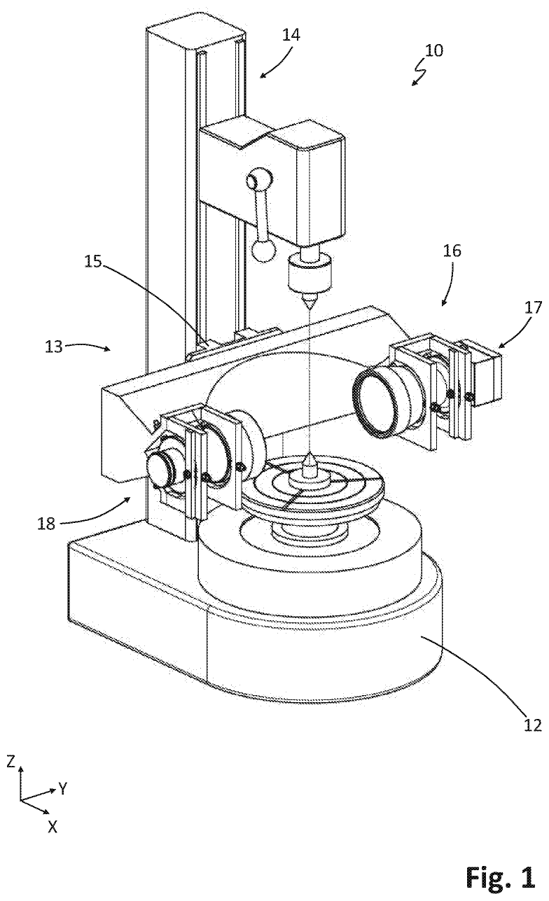

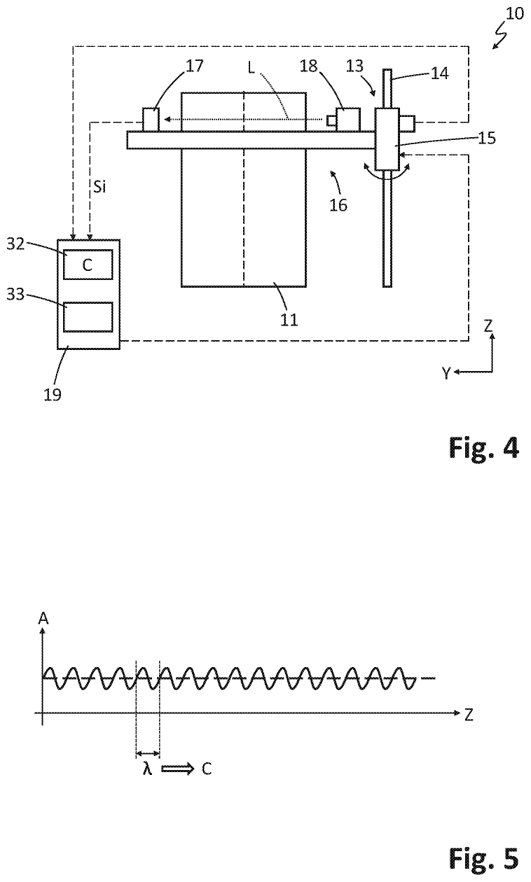

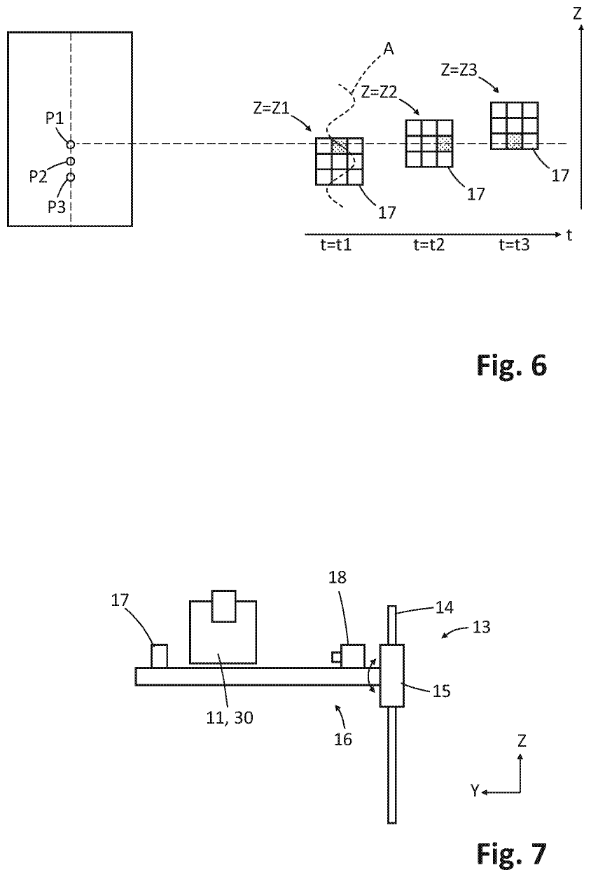

FIG. 1 shows an embodiment of an optical measuring apparatus 10 for measurement of an object, for example a rotationally symmetric object. For example, the measuring apparatus can be configured to detect the contour of the object or the surface profile of the object 11 (FIGS. 4 and 6) in a positioning direction Z. A light emission direction L is orientated orthogonal or in modification to the illustrated embodiment obliquely relative to the positioning direction Z. The positioning direction Z and the light emission direction L can be spatial directions of a cartesian coordinate system X, Y, Z, which is arranged immovably relative to a basis 12 (FIG. 1).

On basis 12 at least one positioning device 13 of the measuring apparatus 10 is arranged. Each positioning device 13 has a guide 14, for example with one or more guide rails, as well as a slide 15 movably arranged along the guide 14 in the positioning direction Z. According to the example, a positioning detection unit (for example scale, which can be detected by a position sensor 20 arranged on the slide) is part of the positioning device 13 and is configured to detect a position of the slide 15 along the guide, wherein this position defines a measuring position Zj (j=1, 2, 3, . . . , m).

Each positioning device 13 defines one positioning direction respectively. In measuring apparatuses 10, which have multiple positioning devices 13, the positioning directions of each positioning device can be orientated in different spatial directions of the coordinate system X, Y, Z. The principle of the invention is explained based on the embodiment of the measuring apparatus 10 with one single positioning device 13. The configuration of optional additional positioning devices 13 can correspond to the embodiment of the positioning device 13 described here. The positioning direction is orientated in the Z-direction in the example and is subsequently denoted as positioning direction Z.

As apparent from FIGS. 1, 6 and 7, a sensor unit 16 is arranged on slide 15. By means of the positioning device 13, sensor unit 16 can be moved relative to the object 11 in positioning direction Z and can be positioned in different measuring positions Zj (j=1, 2, 3, . . . , m). Alternatively or additionally, also the object 11 could be moved relative to sensor unit 16. The number of measuring positions Zj is arbitrary and only exemplarily schematically a first measuring position Z1, a second measuring position Z2 and a third measuring position Z3 of sensor unit 16 relative to object 11 are illustrated in FIG. 6.

In the embodiment positioning device 13 is configured to move sensor unit 16 in positioning direction Z relative to the object 11. Alternatively to this, the positioning device 13 could also be configured to move the object 11 relative to the sensor unit 16. It is also possible that in a modified measuring apparatus 10 at least one positioning device is present in order to move or position sensor unit 16 in at least one positioning direction and/or at least one positioning device is present in order to move or position object 11 in at least one positioning direction. Each present positioning device 13 can thus either move the sensor unit 16 or the object 11 in the respective positioning direction. Important is to carry out the relative movement between sensor unit 16 and object 11.

The sensor unit 16 has a sensor element 17 that is configured to produce one sensor signal Si respectively for multiple measurement points Pi arranged adjacent to one another in positioning direction Z for each measuring position Zj. In FIG. 6 it is highly schematically and only by way of example illustrated that sensor element 17 produces one first sensor signal Si of a first measurement point Pi in different measuring positions Zj. The number of measurement points Pi that can be measured in each measuring position Zj can vary, depending on the configuration of sensor element 17.

The sensor signals Si per measuring position Zj and the number of measuring positions Zj can vary. The letters i, j, are indices, wherein it respectively applies i=1, 2, 3, . . . , n) and j=1, 2, 3, . . . , m), wherein n and m are indices and can be equal or different.

The sensor element 17 of sensor unit 16 can be a metric sensor. The sensor unit 16 is configured to create one sensor signal Si respectively for each measurement point Pi, wherein the sensor signal Si defines the position of the measurement point Pi in at least two directions of the coordinate system X, Y, Z, for example in an X-Z-plane or in another plane that is orientated orthogonal to the light emission direction L. The sensor element 17 can be configured as matrix sensor. Alternatively to this, also another sensor element 17 can be used that can concurrently measure multiple measurement points Pi arranged adjacent to one another in the type of a line in positioning direction Z.

In the embodiment the sensor unit 16 is configured as transmitted light sensor unit. Thereby the sensor element 17 is configured as matrix camera. In light emission direction L or Y a transmitted light illumination 18 is arranged with distance to sensor element 17.

The measuring apparatus 10 comprises in addition a control device 19, which is communicatively connected to the sensor unit 16 and particularly the sensor element 17. The control device 19 also knows the current measuring position Zj between sensor unit 16 and object 11. The control device 19 is configured to control the positioning device 13, so that a desired value for the measuring position Zj is known in the control device 19. In the embodiment positioning device 13 has a position sensor 20 that detects the actual position of slide 15 in positioning direction Z and provides it for control device 19 (FIG. 4).

Due to the configuration of the positioning device 13 and, for example, the support of slide 15 on guide 14, a position deviation can occur between an ideal position of slide 15 and the real position of slide 15. The deviation can cause measurement errors and is reduced or eliminated according to the present invention, which will be explained in detail in the following. The position deviation between the ideal slide position and the real slide position caused by positioning device 13 is described by means of a positioning characteristic.

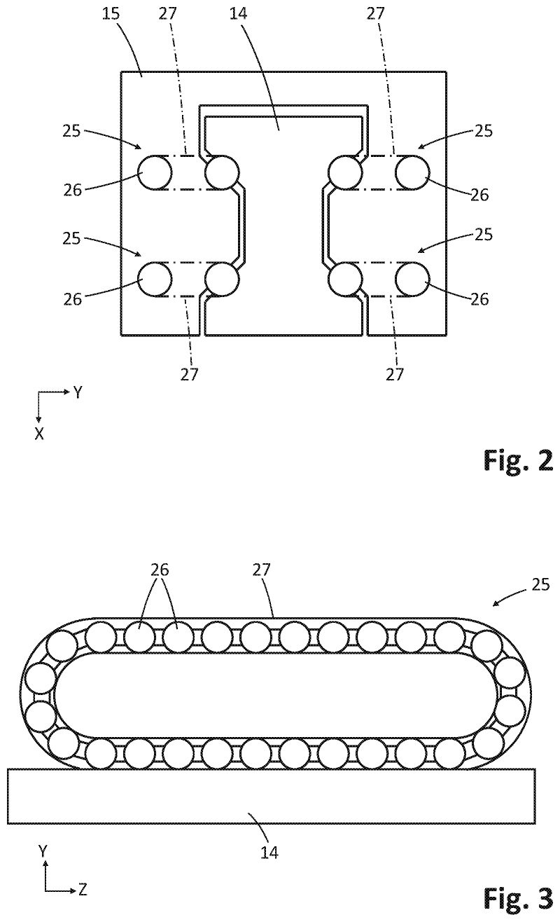

In the embodiment at least one rolling body arrangement 25 is provided for support of slide 15 on guide 14. In the embodiment illustrated in FIG. 2, four rolling body arrangements 25 are illustrated by way of example. Each rolling body arrangement 25 has a multiplicity of rolling bodies 26 that are arranged next to one another along a rolling body track 27. The rolling bodies 26 are balls according to the example. They can form a ball chain extending along the rolling body track. Also, cylindrical rolling bodies 26 could be used alternatively to balls. The rolling body track 27 is closed in the type of a ring. The shape of the rolling body track 27 is curved in sections and straight in sections. At least one section of the rolling body track 27 extends between slide 15 and guide 14 in positioning direction Z. The slide 15 is supported on guide 14 on the rolling bodies 26 arranged between slide 15 and guide 14.

During a relative movement between slide 15 and guide 14 the rolling bodies 26 move along the rolling body track 27 and thus relative to slide 15 and relative to guide 14. Due to the movement of the rolling bodies 26 between slide 15 and guide 14—particularly the entering and/or leaving of rolling bodies 26 in/out of the gap between slide 15 and guide 14—a periodic position deviation A is created between the desired, ideal position of slide 15 and the real actual position of slide 15 in the immovable coordinate system X, Y, Z. The periodic position deviation A can be a translational deviation in at least one spatial direction and/or a tilting or rotating at least around one spatial direction. Because of the periodic position deviation A, sensor signal Si of sensor element 17 is changed.

The periodic position deviation A can be assumed as substantially sinusoidal or cosinusoidal signal. The periodic position deviation A is thus a periodic signal having a spatial wavelength λ as well as an amplitude. The periodic position deviation A is highly simplified schematically illustrated in FIG. 5. For example, the periodic position deviation A along positioning direction Z for a positioning movement of the slide from Zi to Zm can be composed of individual sinusoidal components varying relative to each other that can superimpose each other and/or do not have to directly adjoin one another. The individual sinusoidal components can also be separated or isolated in positioning direction Z. Also, one or multiple characteristic parameters of the occurring sinusoidal components can be different from one another, apart from at least one parameter (positioning characteristic C), which characterizes the periodic position deviation A, particularly the spatial wavelength λ.

For characterizing the periodic position deviation A, a parameter is used according to the invention that can be denoted as positioning characteristic C. This positioning characteristic C can be determined and can be preset for the control device 19. For example, the positioning characteristic C can be stored in a storage, but is part of the control device 19 or with which the control device 19 is communicatively connected.

In the embodiment described here the spatial wavelength λ or another parameter describing the spatial wavelength λ is used as positioning characteristic C. The phase position and the amplitude of the periodic position deviation A remain unconsidered. For correction of the sensor signals Si, it is sufficient to know the spatial wavelength λ or another parameter of the periodic position deviation A describing the spatial wavelength λ and to consider it in form of the positioning characteristic C.

The spatial wavelength λ of the periodic position deviation A can be determined by means of a measurement in that a reference standard is used as object 11. For example, on a cylinder-shaped reference standard the cylinder axis of which is orientated parallel to the positioning direction Z and the outer circumferential surface of which is partly located in the telecentric range of the matrix sensor of the transmitted light arrangement, multiple measurement points are detected on the standard along a surface line. The surface line is particularly orientated parallel to the cylinder axis and to the positioning direction Z. The surface line has a known linear desired profile. Thereby it is sufficient to detect only one single measurement point once in each measuring position by means of the matrix sensor (for example by limitation of the matrix sensor to one single pixel line, which is orthogonal to the positioning direction). The sensor unit 16 (in the present example matrix sensor) has a defined relative position to the position sensor 20. Therefore, by means of position sensor 20, a position in the machine coordinate system X, Y, Z can be assigned to each sensor signal Si of sensor unit 16. For example, the sensor signal Si can be a distance value of the object 11 compared to the reference axis of measuring apparatus 10 depending on the Z-position. In an ideal measuring apparatus 10 the measurement values for the measurement points Pi on the reference standard resulting from the sensor signals Si would produce an ideal linear profile progress, because surface line of the reference standard comprises a constant distance to the sensor unit 16 in the ideal case. In a real measuring apparatus the different and regularly superimposing sinusoidal components of the position deviation A create deviations compared to the linear desired profile. By means of an analysis of the measured real profile, for example by means of a Fourier-analysis, the spatial wavelength λ of the position deviation A can be determined, which is caused by the positioning device 13 used for the measurement.

Additionally or alternatively, the wavelength λ can also be determined by one or more construction parameters of the positioning device 13. In the embodiment the wavelength 2 corresponds substantially to the circumference of the rolling bodies 26.

Additionally or alternatively, it is also possible to consider the distance between two directly adjacent rolling bodies 26 along the rolling body track 27 for calculation of the wavelength λ.

Based on the determined wavelength λ, the positioning characteristic C is obtained. The latter describes a length in positioning direction Z along which the sensor signals Si referring to one common measurement point Pi can be averaged in order to reduce and in the ideal case eliminate the influence of the positioning device 13 on the measurement result.

By means of the control device 19 at least one sensor signal S1 is detected for multiple or all measurement points Pi in different measuring positions Zj respectively. The sensor signals Si referring to one single measurement point Pi vary, depending on the measuring position Zj, as schematically illustrated in FIG. 6. This variation or deviation is caused by the periodic position deviation A. Because the wavelength λ (and/or a parameter correlated therewith) of the periodic position deviation A is known in the control device by means of the positioning characteristic C, a processing of the sensor signals Si from different measuring positions Zj assigned to a common measurement point Pi can be carried out in order to obtain therefrom an averaged measurement value for the measurement point Pi.

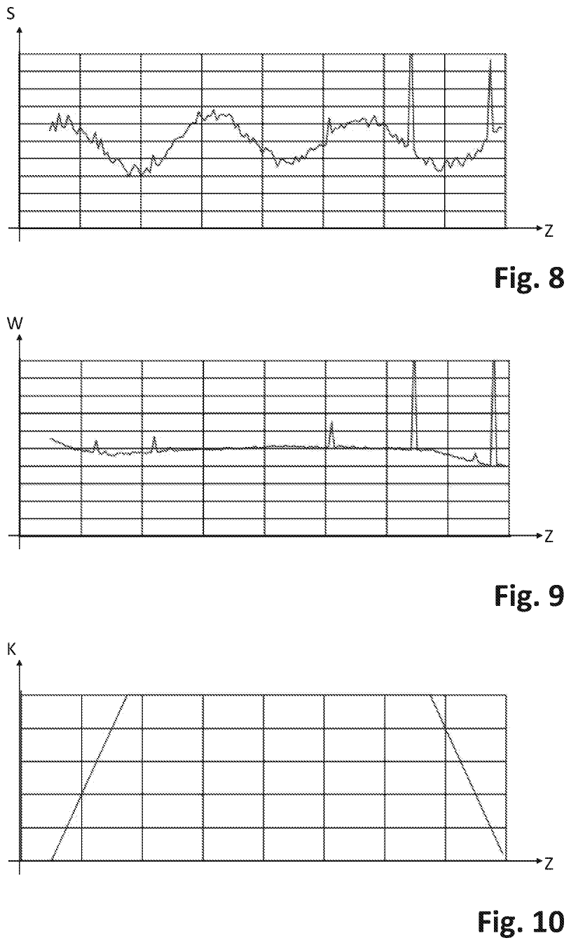

Only schematically and by way of example, the principle is illustrated in FIG. 6. For the first measurement point Pi, for example, one sensor signal M1 is detected in the first measuring position Z1, in the second measuring position Z2 and in the third measuring position Z3 respectively and transmitted to the control device 19. The sensor signals Si(Zj) are influence by the periodic position deviation A in the illustrated measuring positions Z1, Z2, Z3. The three measuring positions Z1, Z2, Z3 are arranged along a length in positioning direction Z that corresponds to one or multiple complete spatial wavelengths λ of periodic position deviation A. The distance of two directly adjacent measuring positions Zj in which one sensor signal Si(Zj) is created for one single measurement point Pi respectively, is particularly no integer multiple of the spatial wavelength λ. In an area corresponding to one or more wavelength λ, the sensor signals Si(Zj) assigned to one common measurement point Pi are averaged, so that the periodic position deviation A is eliminated from the sensor signals Si. In this manner a measurement value W(Pi) is determined or calculated. The elimination of the periodic position deviation A from a sensor signal Si(Zj) for calculation of the measurement value W is apparent from FIGS. 8 and 9.

The periodic position deviation A can be assumed in very good approximation as sinusoidal or cosinusoidal signal. The integral over an integer number of wavelengths λ or periods is, therefore, always equal to zero and in fact independent from the amplitude and the phase position of position deviation A in positioning direction Z or relative to the immovable coordinate system X, Y, Z. It is therefore sufficient to know the spatial wavelength λ or a parameter characterizing the spatial wavelength λ.

By means of comparison of a sensor signal Si for an object 11 and the measurement value W(Pi) determined therefrom under consideration of the positioning characteristic C, it shows that the method according to the invention achieves a very accurate determination of the measurement values W(Pi), which describe the object 11 and are not or only to a minor extent influenced by the periodic position deviation A of positioning device 13.

FIG. 10 shows the number of used sensor signals Si(Zj) from different measuring positions Zj per measurement point Pi. It is apparent that less sensor signals per measurement point are used for the measurement points Pi in positioning direction Z in the range of the start and the end of the measurement, which shows in the progress of the measurement values W(Pi) in FIG. 9. It is therefore advantageous to use for the entire relevant measurement path in positioning direction Z the same or at least a sufficiently large number of sensor signals Si(Zj) per measurement point Pi from different measuring positions Zj respectively in order to obtain the desired accuracy of the measurement value W(Pi).

As schematically illustrated in the block diagram according to FIG. 7, the object 11 cannot only be a workpiece to be measured or a reference standard, but also an additional slide 30 of an additional positioning device 31 of measuring apparatus 10, wherein in this case the workpiece to be measured and/or an additional sensor unit can be arranged on the additional slide 30.

In another advantageous embodiment the measuring apparatus can comprise a method for optimized positioning of sensor unit 16. Thereby sensor unit 16 is moved in positioning direction Z in a target position Zt. In the target position Zt as well as within a wavelength directly arranged in front of the target position (last portion of track of the movement of sensor unit 16 into the target position), the object 11 can be measured by means of sensor unit 16 (therefore is located in the telecentric range of a matrix camera according to the example). For at least one of the measurement point Pt on the object that can be detected in the target position Zt at least for two measuring positions within the wavelength including the target position Zt, sensor signals Si(Zj) are produced and based on the positioning characteristic C, an averaged measurement value W(Pt) of the measurement point Pt assigned to the target position Zt is determined. In an additional step the individual measurement value of the measurement point Pt, which can be detected in the target position Zt (from only one sensor signal St(Zt) without averaging of additional sensor signals from other measuring positions) is determined. Subsequently, this individual measurement value Wt is compared to the averaged measurement value W(Pt) and based thereon a temporal or local correction factor is determined. As long as the measuring position (target position Zt) of sensor unit 16 is not further changed, the subsequent sensor signals can be corrected by means of the correction factor. The correction factor in this case forms a positioning characteristic C, which is only locally valid in the actual measuring position, (that is the target position).

For example, sensor unit 16 can be positioned in the target position Zt in positioning direction Z relative to object 11 according to the positioning method explained above, wherein subsequently statically multiple sensor signals Si(Zt) are produced in this target position Zt, while object 11 is moved around a rotation axis. Because target position Zt of sensor unit 16 remains constant relative to object 11 in positioning direction Z, the sensor signals Si(Zt) detected in the target position Zt, which are associated to different measurement points located in circumferential direction on object 11, can be corrected by means of the temporal correction factor. Therefore, the measurement accuracy of the measurement values W determined therefrom can be improved.

The invention refers to a measuring apparatus 10 and a method for determination of at least one measurement value W of an object 11 described in a coordinate system of the measuring apparatus. By means of a sensor unit 16 for multiple or all measurement points Pi on the object 11, respectively one sensor signal Si is produced, which describes the position of the measurement point Pi, in different measuring positions Zj respectively. By means of a positioning device 13, the sensor unit 16 and the object 11 are moved relative to one another or positioned in the different measuring positions Zj in positioning direction Z. The positioning or relative movement in positioning direction Z is influenced by a periodic position deviation A of positioning device 13 that in turn influences the detected sensor signals Si of measurement points Pi. A positioning characteristic C characterizing the wavelength λ of the periodic position deviation A is determined and preset. By means of this positioning characteristic C, then the sensor signals Si obtained for more or all measurement points Pi in different measuring positions Zj can be corrected in order to obtain the measurement value W for the respective measurement point Pi therefrom.

The method according to the invention can partly also be carried out temporally after detection of the sensor signals Si on the object 11 in the measuring apparatus 10 or a computing unit arranged external from measuring apparatus 10. For example, sensor signals Si from two or more measuring positions Zj assigned to one or more measurement points Pi can be provided to such a computing unit.

The invention also relates to a computer program product. The computer program product can comprise a storage medium. The storage medium can be a memory 32 of control device 19 or a memory, which is communicatively connected with the control device 19. On the storage medium commands are stored that can be executed by means of a processor 33 of control device 19. For this purpose, processor 33 is communicatively connected with the storage medium. Due to the execution of the commands by means of processor 33, an embodiment of the method described above is carried out.

The computer program product can be a part of the measuring apparatus 10 or can be provided separately from the measuring apparatus 10.

### LIST OF REFERENCE SIGNS

10 measuring apparatus
11 object
12 basis
13 positioning device
14 guide
15 slide
16 sensor unit
17 sensor element
18 transmitted light illumination
19 control device
20 position sensor
25 rolling body arrangement
26 roller body
27 rolling body track
30 additional slide
31 additional positioning device
32 memory
33 processor
λ wavelength
A position deviation
C positioning characteristic
K number of sensor signals for each measurement point
Si sensor signal (i=1, 2, 3, . . . , n)
Pi measurement point (i=1, 2, 3, . . . , n)
W measurement value
X spatial direction
L light emission direction
Z positioning direction
Zj measuring position (j=1, 2, 3, . . . , m)

1. A measuring apparatus (10) for determination of a measurement value (W) on an object (11) comprising:
a sensor unit (16) that comprises a sensor element (17) which is configured to produce a sensor signal (Si) for each of a plurality of measurement points (Pi) on the object (11) arranged adjacent to one another in a positioning direction (Z);
a positioning device (13) comprising a slide (15) on which the object (11) or the sensor unit (16) is arranged and which is configured to be moved along a guide (14) in the positioning direction (Z), wherein the positioning device (13) is configured to position the slide (15) at multiple different measuring positions (Zj); and
a control device (19), which is communicatively connected with the sensor unit (16) and configured to receive sensor signals (Si), wherein the control device is configured to assign the sensor signals to assigned measurement points (Pi) on the object (11) and to receive one sensor signal for at least one measurement point respectively in at least two different measuring positions (Zj) of the multiple different measuring positions of the slide (15); and wherein the control device is configured to determine for respectively one measurement point (Pi), for multiple measurement points, or for all measurement points (Pi) of the plurality of measurement points on the object (11), one measurement value (W) respectively based on a predefined positioning characteristic (C) characterizing a periodic position deviation (A) of the positioning device (13) and the sensor signals (Si) for one of the measurement points (Pi) respectively.

2. The measuring apparatus according to claim 1, wherein the object (11) is a workpiece, a reference standard, or an additional slide (30) of an additional positioning device (31).

3. The measuring apparatus according to claim 1, wherein the sensor element (17) is a matrix camera.

4. The measuring apparatus according to claim 1, wherein the control device (19) is configured to determine the predefined positioning characteristic (C) of the positioning device (13) in the positioning direction (Z) using a reference standard as the object (11) or based on at least one construction parameter of the positioning device (13).

5. The measuring apparatus according to claim 1, wherein the sensor unit (16) comprises a transmitted light illumination (18), which is distanced in a light emission direction (L) from the sensor element (17).

6. The measuring apparatus according to claim 5, wherein the light emission direction (L) is orientated obliquely or orthogonally relative to the positioning direction (Z).

7. The measuring apparatus according to claim 1, wherein the control device (19) is configured to predefine a parameter describing a wavelength (λ) as the predefined positioning characteristic (C).

8. The measuring apparatus according to claim 7, wherein the control device (19) is configured to determine the measurement value (W) for one measurement point (Pi) respectively by averaging the sensor signals (Si) of the different measuring positions (Zj) for the one measurement point (Pi) based on the parameter.

9. The measuring apparatus according to claim 1, wherein the positioning device (13) comprises a rolling body arrangement (25) having a plurality of rolling bodies (26) which are configured to circulate in a rolling body track (27) during movement of the slide (15) along the guide (14).

10. The measuring apparatus according to claim 9, wherein the predefined positioning characteristic depends on at least one parameter of the rolling body arrangement (25).

11. The measuring apparatus according to claim 10, wherein the at least one parameter of the rolling body arrangement (25) is a dimension of one of the plurality of rolling bodies (26) of the rolling body arrangement (25) and/or a distance between adjacent ones of the plurality of rolling bodies (26) of the rolling body arrangement (25).

12. The measuring apparatus according to claim 1, wherein the control device (19) and/or the positioning device (13) is configured to position the slide (15) during a measurement in the multiple different measuring positions (Zj) in the positioning direction (Z) without direction reversal.

13. The measuring apparatus according to claim 1, wherein the positioning device (13) comprises a position sensor (20) configured to detect the position of the slide (15) in positioning direction (Z) relative to the guide (14) and to transmit the position to the control device (19).

14. A method for determination of a measurement value (W) on an object (11) comprising:
positioning a slide (15) of a positioning device (13), which is movable in a positioning direction (Z) along a guide (14) in multiple different measuring positions (Zj),
producing multiple sensor signals (Si) corresponding to different ones of the multiple different measuring positions (Zj) for a same measurement point (Pi) on the object (11) respectively by means of a sensor unit (16), and
using the sensor signals (Si) of the same measurement point (Pi) and a predefined periodic positioning characteristic (C) of the positioning device (13) in order to determine at least one measurement value (W).

15. The method according to claim 14, further comprising forming an average of multiple sensor signals (Si) of the same measurement point (Pi) for determination of the predefined periodic positioning characteristic (C) during movement of the slide (15) in a target position.

16. The method according to claim 15, further comprising determining a temporal or local correction factor as the predefined periodic positioning characteristic (C) for the target position based on the average of the multiple sensor signals (Si) of the same measurement point (Pi) and based on one single sensor signal (Si) of the same measurement point (Pi) in the target position.

17. A computer-readable program product for a measuring apparatus (10), the computer-readable program product comprising a storage medium storing commands, which cause the measuring apparatus (10) to carry out the method according to claim 14 when the commands are executed by a control device of the measuring apparatus (10).
